(19) United States
(12) Patent Application Publication
(10) Pub. No.: US 2006/0001760 A1
(43) Pub. Date: Jan. 5, 2006

(54) Apparatus and method for object shape detection

(75) Inventors: Koichi Matsumura, Bracknell (GB); Masamichi Masuda, Tokyo (JP)

Correspondence Address: FITZPATRICK CELLA HARPER & SCINTO, 30 ROCKEFELLER PLAZA, NEW YORK, NY, 10112, US

(73) Assignees: CANON TECHNOLOGY EUROPE LTD., Reigate (GB); CANON EUROPA NV, Amstelveen (NL)

(21) Appl. No.: 11/155,631

(22) Filed: Jun. 20, 2005

(30) Foreign Application Priority Data
Jun. 23, 2004 (GB) 0414097.6

(51) Int. Cl. H04N 5/225

(52) U.S. Cl. 348/335

(57) ABSTRACT

A light projecting device including a two-dimensional array of light projecting elements is used to project light towards an image capturing device. An arrangement for mounting an object to be modelled is provided between the light projecting device and the image capturing device. The light projecting elements are arranged to direct light towards said image capturing device, whereby a silhouette of the object is generated at the image capturing device. The silhouette is used for generating a three-dimensional model of the object.

This invention relates to object shape detection using a backlight unit to create a silhouette of an object, with the shape of the object being determined from that silhouette. In particular, the invention relates object shape detection that is suitable for use with reflective objects.

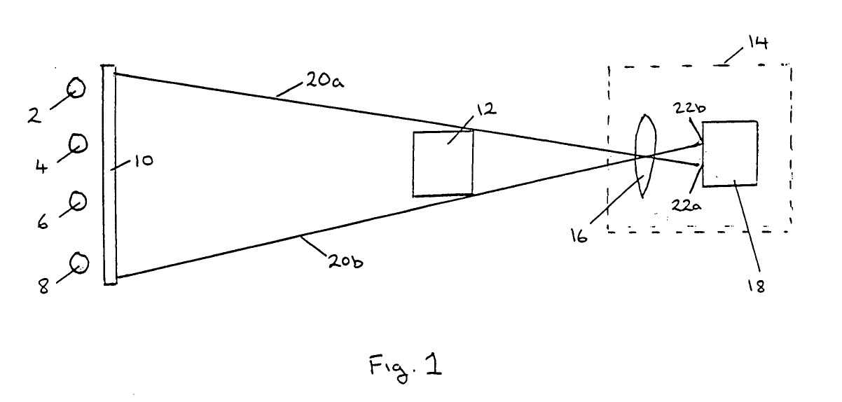

It is known in the art to determine the shape of an object by using a backlight to generate a silhouette of the object and to determine the shape of the object using a threshold technique, as described below with reference to FIG. 1.

FIG. 1 shows light sources 2, 4, 6 and 8, a diffusion panel 10, an object being measured 12 and a camera 14 comprising a taking lens 16 and an imaging device 18. The light sources 2, 4, 6 and 8 emit light in all directions and the diffusion panel 10 acts to scatter the light received from those light sources to provide a source of substantially isotropic lighting. The taking lens 16 is a converging (or positive) lens that takes light received from the light sources and focuses that light into the imaging device 18.

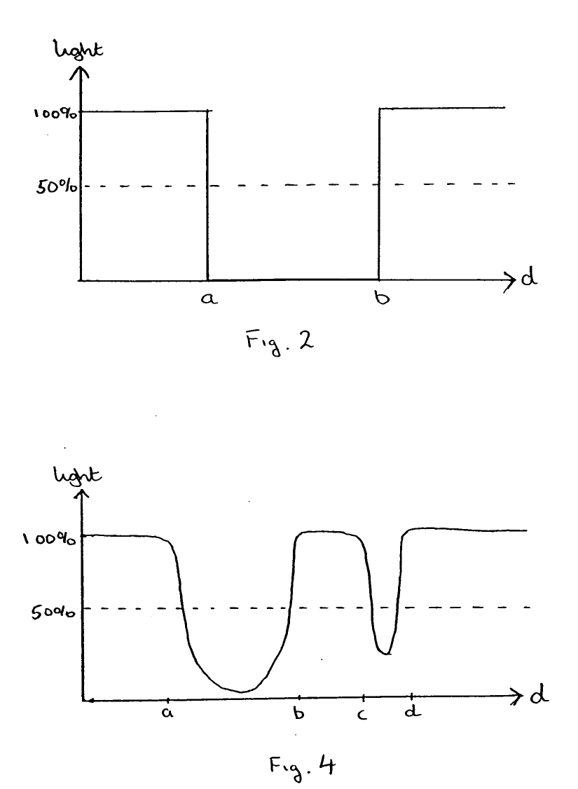

Two exemplary beams of light are shown in FIG. 1. A first beam 20a just misses the top right-hand corner of the object 12 as shown in FIG. 1 and passes through the centre point of the lens 16 before reaching the camera at point 22a. A second beam 20b just misses the bottom right-hand corner of the object 12 as shown in FIG. 1 and passes through the centre point of the lens 16 before reaching the camera at point 22b. No light is received at the imaging device 18 between the points 22a and 22b. This is shown in FIG. 2, which shows the light profile for the system of FIG. 1 in ideal circumstances, ignoring the possible presence of a penumbra and any effects of diffraction.

FIG. 2 shows the light received at the imaging device over a distance d. The point 22a is labelled a in FIG. 2: the point 22b is labelled b in FIG. 2. As shown in FIG. 2, the area between points 22a and 22b receives no light from the light sources 2, 4, 6 and 8 and so a silhouette is formed. The size of the object can be determined from that silhouette provided that the position of that object relative to the light source and the imaging device is known.

A problem with the method described with respect to FIGS. 1 and 2 is that it does not work well when the object 12 is reflective.

FIG. 3 shows the system of FIG. 1 when used to determine the size and shape of a reflective object. The system of FIG. 3 consists of light sources 2′, 4′, 6′ and 8′, a diffusion panel 10′, and a camera 14′ comprising a taking lens 16′ and an imaging device 18′. An object being measured is shown positioned between the diffusion panel and the imaging device. In the example of FIG. 3, the object being measured is a metal cup, shown in cross-section in FIG. 3, the cup having a cylindrical main body 12′ and a handle 13′ with both the main body 12′ and the handle 13′ having reflective surfaces.

Two beams of light 20a′ and 20b′ are shown in FIG. 3 and are similar to the beams of light 20a and 20b of FIG. 1, with the beam 20a′ just missing the top of the main body 12′ of the object being measured and passing thorough the centre point of the lens 16′ before reaching the imaging device at point 22a′ and the beam 20b′ just missing the bottom of the main body 12′ before passing through the centre point of the lens 16′ before reaching the imaging device at point 22b′. In addition, a third beam of light 21′ is shown that strikes the handle 13′ and is reflected towards the imaging device 18′. As shown in FIG. 3, the beam 21′ strikes the imaging device outside the region between the points 22a′ and 22b′. Reflections from both the main body 12′ and the handle 13′ of the cup are reflected in a number of different ways, with the result that the clear definitions of the edges of the silhouette shown in FIG. 2 become blurred.

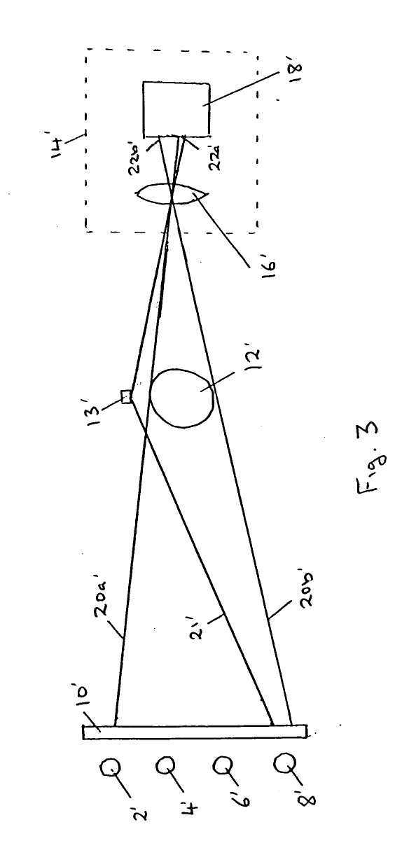

FIG. 4 shows an exemplary light profile for the system of FIG. 3. FIG. 4 shows the light received at the imaging device over a distance d. The point 22a′ is labelled a in FIG. 4: the point 22b′ is labelled b in FIG. 4. The points a and b on FIG. 4 mark the positions of the edge of the silhouette of the cylindrical main body 12′ of the cup, in an ideal system. FIG. 4 also shows positions c and d that mark the positions of the edge of a silhouette of the handle 13′ in an ideal system.

The problem of reflections blurring the edges of silhouettes is clearly shown in the examples of FIGS. 3 and 4, but also exists in the example of FIGS. 1 and 2 when the object 12 is reflective. In particular, incoming light at low angles can glance of the surface of the object and finds its way into the area that should form part of the silhouette.

One known technique for determining the position of the edge of an object is a system such as that of FIGS. 1 and 3 is thresholding. The thresholding technique sets a light level, perhaps 50% of the maximum light level, that is taken to mark the edge of the silhouette (and hence the edge of the object being measured). Clearly, the thresholding technique would accurately define the edges of the object in the example of FIGS. 1 and 2 but would be much less accurate in the example of FIGS. 3 and 4.

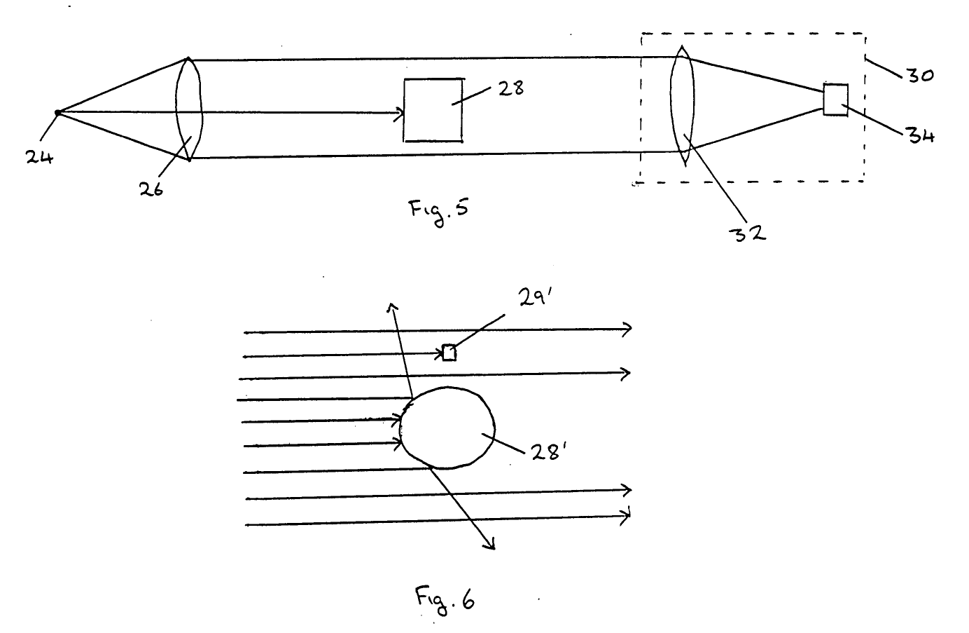

The problem of generating accurate silhouettes from reflective images is known in the art and one known solution is to use collimated lighting, as described below with reference to FIGS. 5 and 6.

The system of FIG. 5 comprises a point light source 24 positioned at the focal point of a converging lens 26. As is well known in the art, positioning a point light source at the focal point of a lens results in collimated lighting, as shown schematically in FIG. 5. An object being measured 28 is placed in the collimated light, between the lens 26 and the camera 30. The camera 30 comprises a taking lens 32 and an imaging device 34 and is used to generate a silhouette image in a similar manner to the imaging devices described above with reference to FIGS. 1 and 3.

FIG. 6 shows a close-up of an object being measured using the system of FIG. 5. The object is a cup similar to that shown in FIG. 3 and comprises a main body 28b′ and a handle 29b′. FIG. 6 also shows a series of exemplary parallel light beams. As can be seen in FIG. 6, it is possible that a very small amount of light could be reflected from the main body 28b′ onto the handle 29′ and from there into the camera 30, but the amount of reflected light that will reach the imaging device 34 in the areas that should ideally be dark will be very small. Accordingly, the edges of the silhouette observed by the imaging device 34 will be much clearer than in the example of FIGS. 3 and 4. Furthermore, the well-known problem of penumbra does not arise when collimated lighting is used.

The effects of diffraction of light have been ignored in the analysis given above. This is because the effects of diffraction in the systems in which the present invention is intended to be used are much smaller than the effects of reflection and so the effects of diffraction can be overlooked.

There are a number of problems with the system of FIG. 5.

In order for the system of FIG. 5 to take images of quite large objects, the lens 26 must have a large diameter. Further, the system of FIG. 5 requires the light source to be placed at the focal length of the lens. The ratio of the diameter of a lens to the focal length of that lens is termed the F-stop or F-number of the lens. An F-stop value of the order of 1 generally leads to significant colour aberrations; values of 2, 3 or 4 are preferred. It follows that the system of FIG. 5 will require a large, heavy lens having a long focal length (perhaps two or three times the diameter of the lens), resulting in a large and heavy optical system. In one exemplary use of the system of the present invention, the light unit (including the light source) is moved so that the silhouette of the object being measured can be taken from different positions or different orientations. Clearly, the use of a light source having a long focal length and incorporating large and heavy lens is a problem, especially if that light source is to be moved.

The use of collimated light is effective to reduce the problems caused by reflected light, but in order to capture enough of the light that passes the object to make an effective silhouette, the optical system of the image capturing device must be of a similar size to that of the light source (since the light from the light source is parallel). Thus, not only is the light source large and heavy, the image capturing device is also large and heavy.

The present invention seeks to overcome at least some of the problems identified above.

The present invention provides an apparatus for generating a silhouette of an object, the apparatus comprising a light projecting device, an image capturing device and an arrangement for mounting the said object between the light projecting device and the image capturing device, wherein said light projecting device includes a two-dimensional arrangement of light projecting elements, each light projecting element having a light source associated therewith, and wherein the light projecting elements are arranged to direct light towards said image capturing device, whereby a silhouette of said object is generated at said image capturing device.

The present invention also provides a light projecting device arranged, in use, to generate a silhouette of an object, the device including a two-dimensional arrangement of light projecting elements, each light projecting element having a light source associated therewith, wherein the light projecting elements are arranged, in use, to direct collimated or converging light towards said object.

The light projecting elements may be arranged to direct collimated light towards said image capturing device. Alternatively, the light projecting elements may be arranged to direct converging light towards said image capturing device.

Each light projecting element may comprise a converging lens arranged to direct light from the associated light source towards said image capturing device. Each light source may be positioned at the focal point of the lens with which it is associated. Each light source may be positioned relative to the lens with which it is associated such that converging light is directed towards said image capturing device. Each of said light sources may be a light emitting diode.

In one form of the invention, each of said converging lenses is a fresnel lens. This is advantageous due to the small size and low weight of fresnel lenses.

The converging lenses may be arranged in a honeycomb pattern, for example a honeycomb arrangement of hexagonal lenses. This is advantageous as it leads to fewer problems with colour aberrations compared to a rectangular arrangement of lenses of similar size.

The light projecting device may further comprise an additional converging lens positioned between said light projecting elements and said object. That additional converging lens may be a fresnel lens.

In one form of the invention, each of said light sources includes a mechanical adjustment mechanism for altering the position of that light source relative to the lens with which it is associated. Each light source may be moveable along an x-axis and a y-axis in order to align the light source with the centre of the lens with which it is associated. Alternatively, or in addition, each light source may be movable along a z-axis in order to position the light source either closer to, or further away from, the lens with which it is associated.

The image capturing device preferably includes a taking lens to form a camera.

In one form of the invention, one or more mechanical supports provide mechanical support to one or more of said the lenses of said light projecting elements. For example, a mechanical support may be provided between the lenses of said light projecting elements and said additional converging lens. Alternatively, or in addition, a mechanical support may be provided on the side of said additional converging lens facing said image capturing device.

In one form of the invention, the light projecting device is movable relative to said arrangement for mounting the said object in order to generate silhouettes of said object from different view points.

The present invention also provides a method of generating a silhouette of an object, the method comprising the steps of:
placing the said object between a light projecting device and an image capturing device;
directing light from a two-dimensional arrangement of light sources within the light projecting device towards the image capturing device; and
generating a silhouette of the object at the image capturing device.

The method may also include the step of converting the light from the light sources into either collimated or converging beams of light.

By way of example only, embodiments of the present invention will now be described with reference to the accompanying schematic drawings, of which:

FIG. 1 shows a known system for determining the shape of an object by measuring the silhouette generated by that object;

FIG. 2 shows an ideal light profile for the system of FIG. 1;

FIG. 3 shows the use of the system of FIG. 1 to measure the shape of a reflective object;

FIG. 4 shows an exemplary light profile for the system of FIG. 3;

FIG. 5 shows an alternative system for determining the shape of an object using principles known in the art;

FIG. 6 shows a close-up of part of the system of FIG. 5 when used to measure the shape of a reflective object;

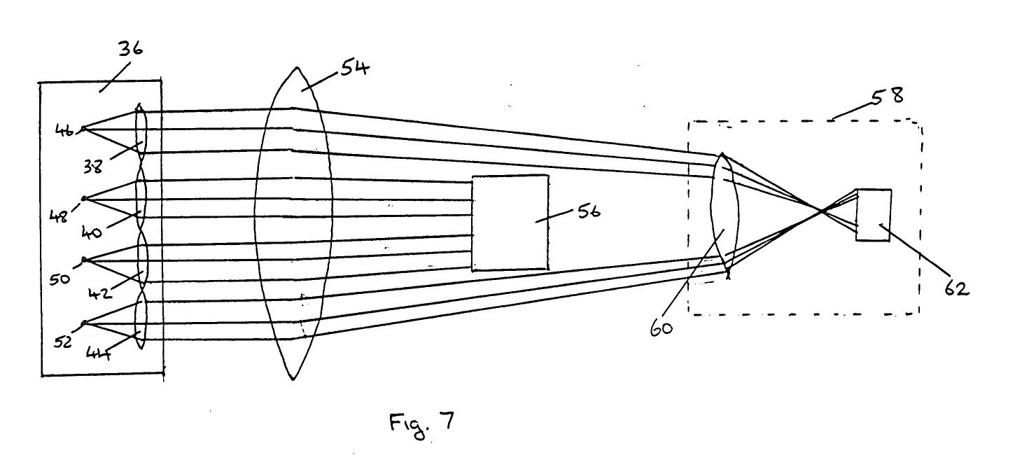

FIG. 7 shows an imaging system in accordance with an embodiment of the present invention;

FIG. 8 shows a first arrangement of the array of lenses of the apparatus of FIG. 7;

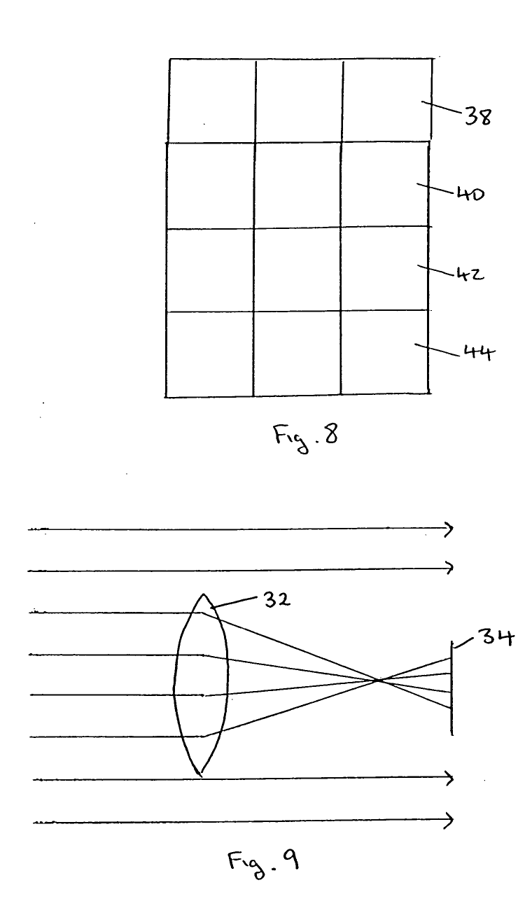

FIG. 9 shows the use of the imaging device of FIG. 5 in the absence of an object being measured;

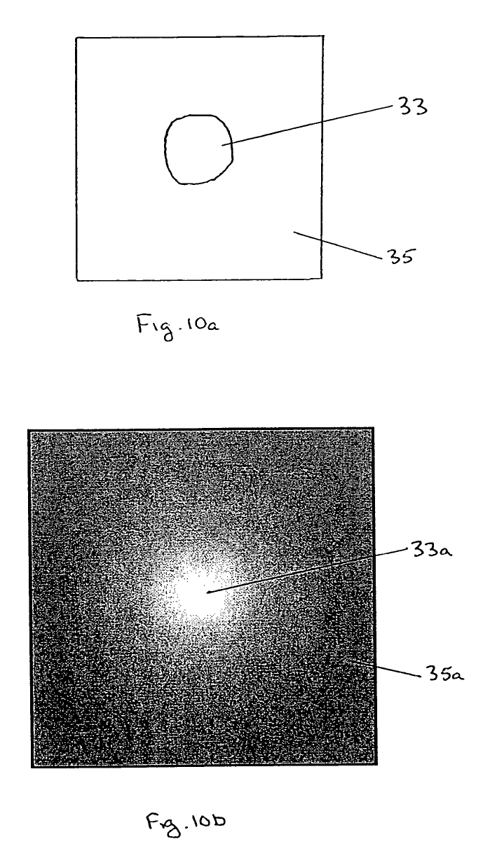

FIG. 10a shows schematically an image generated using the system of FIG. 9;

FIG. 10b shows an exemplary image produced using the system of FIG. 9;

FIG. 11 shows the use of the imaging device of FIG. 7 in the absence of an object being measured;

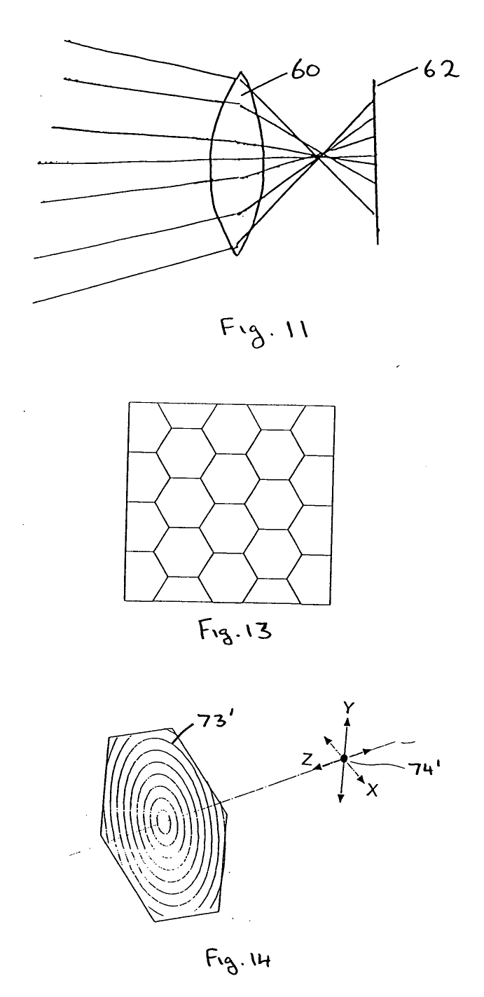

FIG. 12 shows an imaging system in accordance with an embodiment of the present invention;

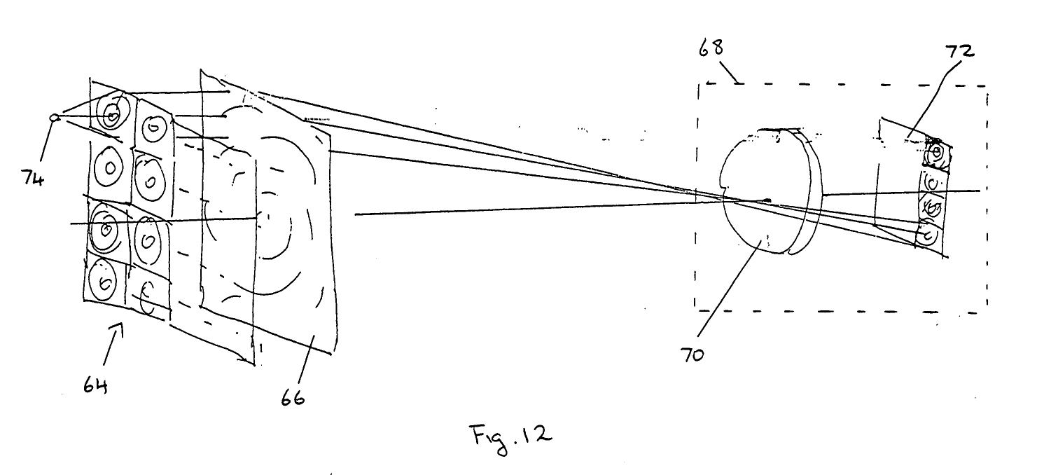

FIG. 13 shows an alternative arrangement of an array of lenses in accordance with an aspect of the present invention;

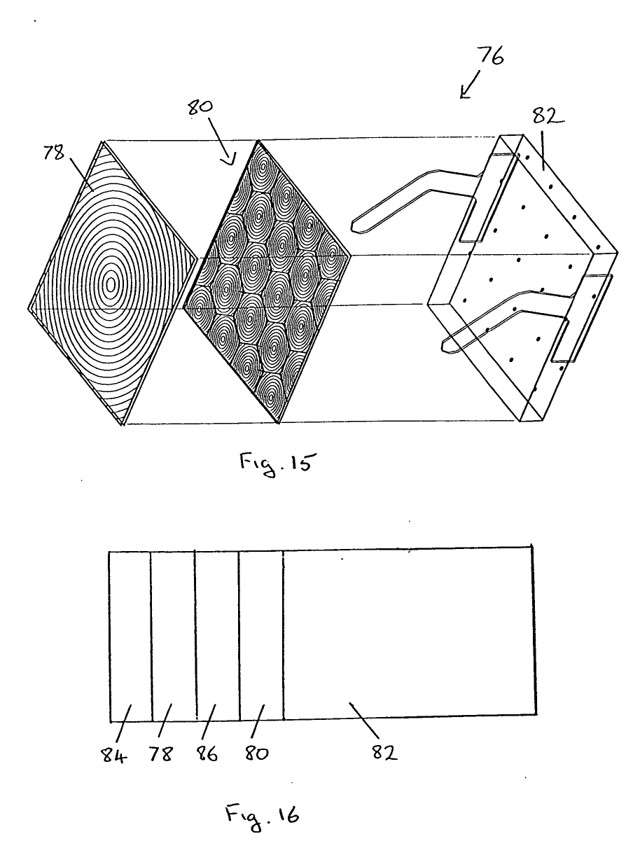

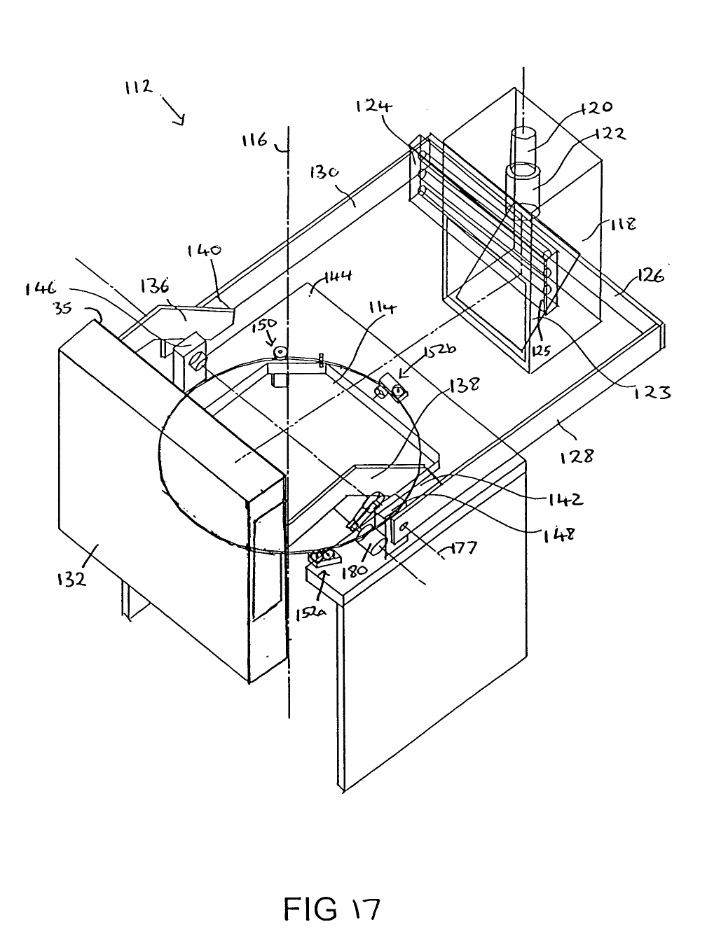

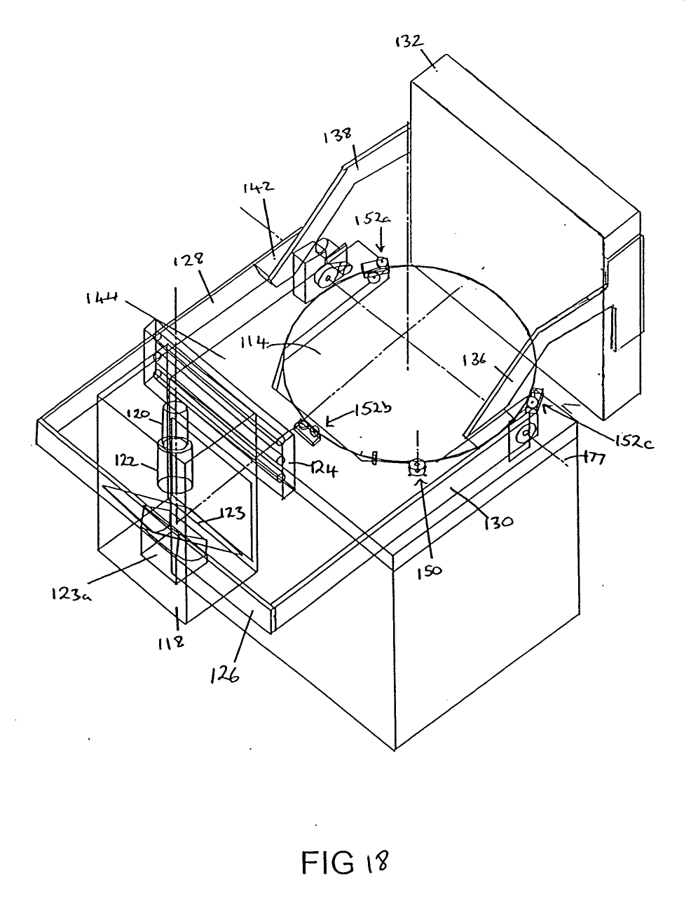

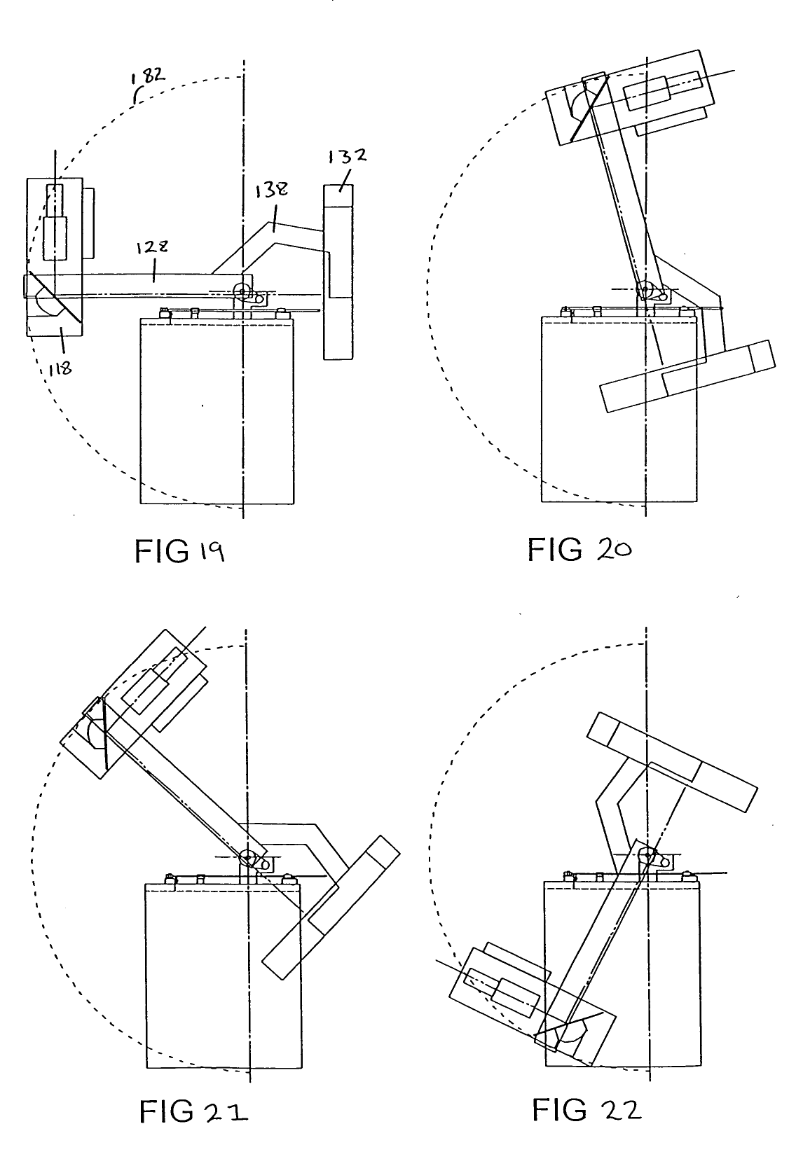

FIG. 14 demonstrates the positioning of a light source in accordance with an aspect of the present invention;

FIG. 15 is an exploded view of a light unit in accordance with an embodiment of the present invention;

FIG. 16 is a cross-sectional, schematic view of the light unit of FIG. 15;

FIG. 17 is an isometric view of a photographic apparatus of in which a measuring system in accordance with the present invention can be used, viewed from a first direction;

FIG. 18 is an isometric view of the photographic apparatus of FIG. 17, viewed from a second direction;

FIG. 19 is a side view of the photographic apparatus of FIG. 17 with the camera arm in a horizontal position;

FIG. 20 is a side view of the photographic apparatus of FIG. 17 with the camera arm in a first position above the horizontal;

FIG. 21 is a side view of the photographic apparatus of FIG. 17 with the camera arm in a second position above the horizontal;

FIG. 22 is a side view of the photographic apparatus of FIG. 17 with the camera arm in a position below the horizontal;

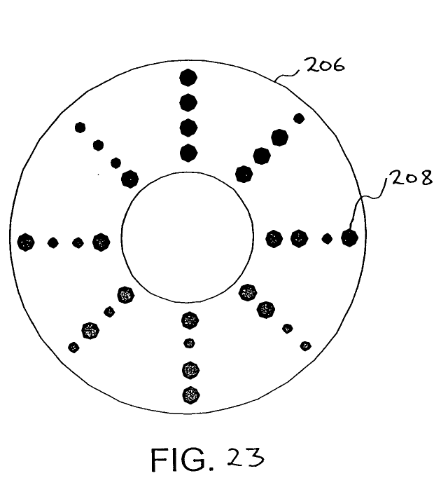

FIG. 23 shows a calibration mat for use with the photographic apparatus of FIG. 17; and

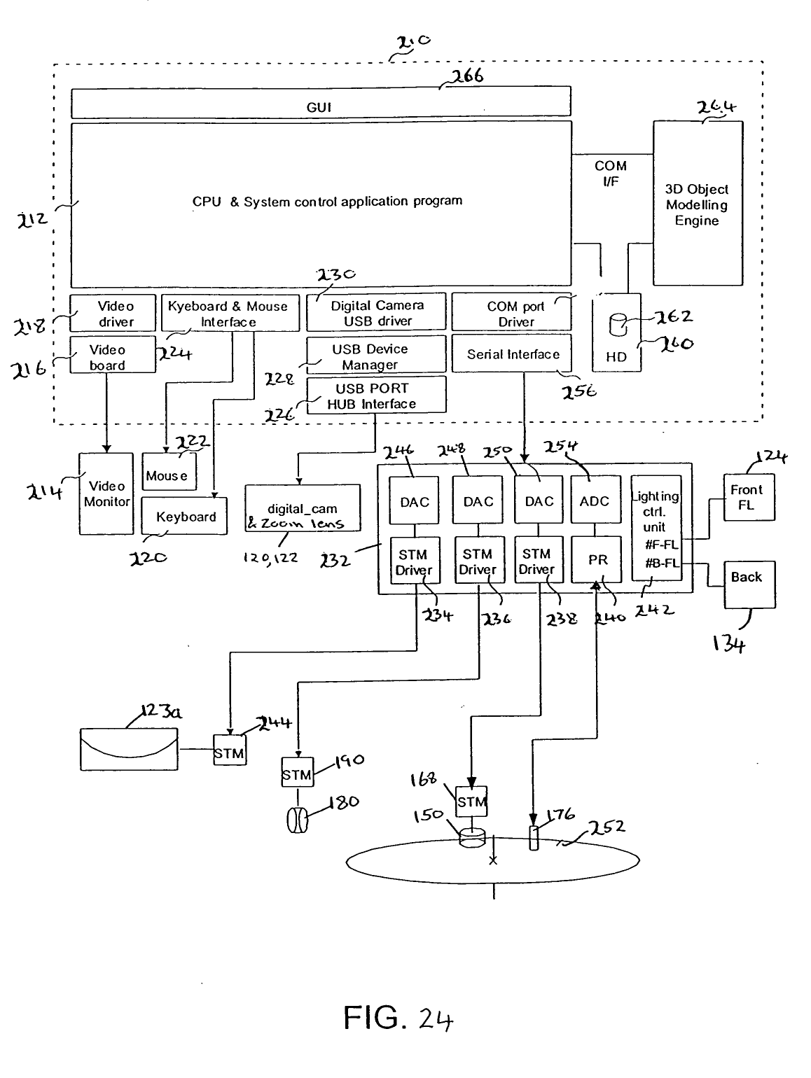

FIG. 24 shows a block diagram of a three-dimensional modelling system in which the measuring system of the present invention may be used.

A first embodiment of the present invention is described below with reference to FIGS. 7 and 8. FIG. 7 shows a system having a 2-dimensional array of lenses 36, a second lens 54, an object being measured 56, and a camera 58 comprising a taking lens 60 and an imaging device 62. The 2-dimensional array of lenses 36 shown in FIG. 7 is a cross-section in which lenses 38, 40, 42 and 44 are shown. As shown in FIG. 8, the lenses shown in the array 36 of FIG. 7 are the lenses along the right-hand side of that array. Each convex lens, for example, lenses 38, 40, 42, or 44, of the array is arranged in a rectangular matrix, as shown in the FIG. 8.

Each of the lenses in the array 36 has a light source associated therewith, with that light source being positioned at the focal point of the lens (light sources 46, 48, 50 and 52, associated with lenses 38, 40, 42 and 44 respectively, are shown in FIG. 7). As discussed above, by placing the light source (such as a light emitting diode) at the focal point of the lens, that lens will convert the radial light from the light source into collimated light, as shown schematically in FIG. 7.

The lens 54 takes the collimated light from the array 36 and converges that light towards the camera 58. The object being measured 56 blocks part of the converging light so that the imaging device 62 forms a silhouette, as described with reference to the prior art above.

The system described with reference to FIGS. 7 and 8 has a number of advantageous features. As described above, the focal length of the lens might typically be at least twice the diameter of the lens, in order to keep colour aberrations down to an acceptable level. By using an array of small lenses (rather than one large lens), the focal length of each lens can be made much smaller without leading to unacceptable levels of colour aberration. Accordingly, using an array of lenses leads to a system in which the light sources can be placed closer to the lenses, thereby reducing the overall size of the light unit.

A further advantage of using a plurality of light sources, rather than a single light source, is that the amount of light being used can be increased, thereby improving the quality of the images generated by the imaging device 62.

A third advantage with the system of FIGS. 7 and 8 results from the provision of the second converging lens 54 and is explained below with reference to FIGS. 9 to 11.

FIG. 9 shows the taking lens 32 and imaging device 34 of the system of FIG. 5, in which the object 28 has been removed so that no light is blocked. If the incoming light is parallel (i.e. collimated), the taking lens 32 focuses that light towards the focal point of the taking lens. It follows that an image taken by the imaging device 34 positioned close to the focal point will have a very bright central circle 33 surrounded by a dark area 35, as shown schematically in FIG. 10a, since all the incoming light is focused towards the central area of the imaging device. FIG. 10b shows an image taken with an imaging device used in an arrangement similar to that of FIG. 9. The image of FIG. 10b shows a bright central area 33a surrounded by a dark area 35a similar to the schematic representation shown in FIG. 10a.

FIG. 11 shows the taking lens 60 and imaging device 62 of the system of FIG. 7, in which the object 56 has been removed so that no light is blocked. The incoming light is converging. The taking lens 60 focuses the light, but now the light seen by the imaging device is spread over a wider area so that images taken by the imaging device have a more even and uniform light distribution, so that the problem of having bright central area and surrounding dark area, as shown in FIGS. 10a and 10b, does not occur.

In one form of the invention, the lens 54 has a focal length similar to the distance between the lens 54 and the camera 58.

A further problem associated with prior art systems, as discussed above, is the size and weight of the lenses required. The system of FIG. 7 can be further improved by replacing the lens 54 and/or the array of lenses 36 with fresnel lenses.

As is well-known in the art, a fresnel lens has a surface of stepped concentric circles and is much flatter than a conventional lens having the same focal length. Accordingly, replacing one or more of the lenses of FIG. 7 with one or more fresnel lenses reduces the size and weight of the lenses used. FIG. 12 is a schematic view of a system in accordance with an embodiment of the present invention in which the lenses of the system of FIG. 7 are replaced with fresnel lenses.

The system of FIG. 12 comprises an array of fresnel lenses, indicated generally by the reference numeral 64, a large fresnel lens 66, and a camera 68 comprising a taking lens 70 and an imaging device 72. The array of fresnel lenses 66 consists of a 2D array of lenses, each having a light source associated therewith. An exemplary light source 74 is shown in FIG. 12. Some of the fresnel lenses in the array 66 are omitted for clarity and all light sources with the exception of light source 74 are omitted, again for clarity.

Each light source in the system of FIG. 12 is positioned at the focal point of the fresnel lens with which it is associated. Accordingly, the light from the array 64 is collimated. It follows that the system of FIG. 12 works in the same manner as the system of FIG. 7. The principal difference is the size and weight of the lenses used.

The lenses of the array 64 are arranged in a square pattern in a similar manner to that shown in FIG. 8. This arrangement can cause problems with colour aberrations in the resulting image.

The focal length of a lens is dependent on the wavelength of the light. Chromatic aberrations are caused by the different focal lengths of different colours of light and are made worse as the distance between the centre and the edges of a lens increases. Accordingly, using square lenses as shown in FIG. 12 results in chromatic aberration caused by light arriving near the corners of those lenses. Clearly, the problem can be reduced by replacing the square lenses with circular lenses, but this does not fit well into an array. A better solution is to use an array arranged as a honeycomb of lenses, such as the array of hexagonal lenses shown in FIG. 13.

FIG. 14 shows one of the hexagonal fresnel lenses 73′ of the hexagonal array shown in FIG. 13. Also shown in FIG. 14 is a light source 74′ for that lens. A light emitting diode may be used as the light source 74′. In practice, due in part to mechanical inaccuracies in the manufacture of light emitting diodes, it is difficult to ensure that each light source is correctly aligned in the lens array. Accordingly, in one embodiment of the invention, each light source is movable in three axial directions, as represented in FIG. 14 by the x- y- and z-axes. Movements along the x- and y-axes align the light source with the centre of the lens. Movements along the z-axis ensure that the light source is positioned at the focal point of the lens.

Of course, the honeycomb arrangement of lenses shown in FIG. 13 can also be applied to the array of lenses 36 of FIG. 7.

FIG. 15 shows an exploded view of a light unit, indicated generally by the reference numeral 76, in accordance with an embodiment of the present invention. The light unit 76 comprises a main fresnel lens 78, a hexagonal array of fresnel lenses indicated generally by the reference numeral 80, and an array of light sources 82, each light source being associated with one of the lenses of the array.

FIG. 16 is a cross-sectional view of the light unit 76, including the main fresnel lens 78, hexagonal array 80 of fresnel lens and the array of light sources 82. A support 84, for example, made of thin plain glass is provided on the exterior of the fresnel lens 78 to provide a mechanical support for that lens. A second support 86, for example made of thin plain glass, is provided between the array of lenses 80 and the lens 78 to provide further mechanical support.

The supports 84 and 86 prevent the thin fresnel lenses from distorting caused by bending of the lenses. In one form of the invention, the supports 84 and 86 have a width of 2 mm. The supports 84 and 86 may be made of glass, which is advantageous because the optical properties of glass can be controlled; however other materials, such as acrylics, could be used.

One exemplary use of a light unit in accordance with the present invention, such as the light unit 76 described above, is in a system for generating a three-dimensional model of an object from a plurality of two-dimensional images taken from a plurality of positions. It is known that three-dimensional models of devices can be generated by determining the silhouettes of a number of photographed images of the device and using those silhouettes to generate a three-dimensional model of the object, the model consisting of a number of polygons. Photographed images are used to generate textures for application to each polygon of the three-dimensional images to generate the final model of the object.

FIGS. 17 and 18 shows two views of a photographic apparatus, indicated generally by the reference numeral 112, for generating three-dimensional modules that makes use of a light unit in accordance with the present invention.

Photographic apparatus 112 includes a glass turntable 114 on which an object to be photographed can be placed. The glass turntable is rotatable about a central vertical axis 116 to enable an object placed on the turntable 114 to be photographed from many angles. A camera unit 118 is provided to take photographic images of an object on the turntable 114. The camera unit 118 comprises a camera 120, a zoom lens 122 and a mirror 123 with a tilting mechanical stage 123a. The zoom position of the zoom lens 122 is electrically controllable. Detailed descriptions of suitable controlling mechanisms for such a zoom lens are omitted from the present description since they do not relate directly to the present invention and suitable implementations are well known to persons skilled in the art.

A front fluorescent light unit 124 is provided on the camera unit 118 and a diffusion panel 125 is provided in front of the front fluorescent light unit to diffuse the light from front fluorescent light unit 124, to reduce glare from the light unit, for example. The front fluorescent light unit 124 is used to provide appropriate lighting to enable the camera 120 to take photographs of an object placed on the turntable 114 for the generation of textural data for use by the three dimensional modelling software. The camera unit 118 is mounted on a central camera arm 126. Central camera arm 126 extends from a left camera arm 128 to a right camera arm 130.

A backlight unit 132, such as the light unit 76 of FIG. 15, is positioned such that an object placed on the turntable 114 is located between the backlight unit 132 and the camera unit 118. The backlight unit 132 is illuminated when the camera unit 118 is being used to capture a silhouette image of an object placed on the turntable 114.

The backlight unit 132 is mounted between a right backlight arm 136 and a left backlight arm 138. The right backlight arm 136 is connected to the right camera arm 130 by a right arm joint 140. The left backlight arm 138 is connected to the left camera arm 128 by a left arm joint 142.

A frame 144 is provided to support the elements that support the turntable 114 (described further below). Further, a right arm pillar 146 extends from the support frame 144 to the right camera arm 130 to support the right camera arm 130 and the right backlight arm 136. In a similar manner, a left arm pillar 148 extends from the support frame 144 to the left camera arm 128 to support the left camera arm 128 and the left backlight arm 138.

The turntable support frame 144 includes a drive wheel arrangement indicated generally by the reference numeral 150, a first support wheel arrangement indicated generally by the reference numeral 152a, a second support wheel arrangement indicated generally by the reference numeral 152b and a third support wheel arrangement indicated generally by the reference numeral 152c. The support wheel arrangements 152a, 152b and 152c are provided to support to the glass turntable 114. The drive wheel arrangement 150 supports the turntable and is also provided to rotate the turntable as required.

As shown in FIGS. 17 and 18, each camera arm (camera arm left 128 and camera arm right 130) is attached to the corresponding backlight arm (backlight arm left 138 and backlight arm right 136 respectively) via an arm joint (left arm joint 142 and right arm joint 140 respectively). The camera arms and the backlight arms are held at a fixed position with respect to one another by the arm joints, but those arms can be rotated relative to the glass turntable about an axis of rotation 177.

The left and right camera arms 128 and 130, and the left and right backlight arms 138 and 136, are connected together and can be rotated relative to the turntable 114 by arm drive 180. FIGS. 19 to 22 show the camera and backlight arms in a number of different positions relative to the turntable.

In FIG. 19, the left camera arm 128 is horizontal, i.e. it extends along the axis of the turntable 114. In FIG. 20, the left camera arm 128 is orientated 80 degrees above the axis of the turntable 114. In FIG. 21, the left camera arm 128 is orientated 45 degrees above the axis of the turntable 114. In FIG. 22, the left camera arm 128 is orientated 70 degrees below the axis of the turntable 114 (or at an angle of −70 degrees relative to the turntable). The camera arm is driven by arm drive 180 and the arm rotation position (or elevation angle) is controlled by driving the stepping motor 190 shown in the FIG. 24.

In the use of the photographic apparatus 112 to capture a plurality of images of an object, different images can be taken at different elevations. For example, views can be taken at raised positions relative to the turntable (as in FIGS. 20 and 21) and below the object (as in FIG. 22). Clearly, the arm drive 180 of the photographic apparatus 112 is able to position the camera arm in any position on the arc 182; the angles shown in FIGS. 19 to 22 are merely exemplary.

As shown in FIGS. 19 to 22, the camera unit 118 and the backlight unit 132 rotate relative to turntable 114 on which an object to be modelled can be placed. Thus, the same backlight unit 132 is used for all positions of the camera 120. This ensures uniformity in the distance from the camera 120 to the backlight unit 132 and also ensures uniformity in the brightness and hence in the image generated. The use of a single movable backlight unit is preferable to the use of multiple fixed backlight units for a number of reasons. For example, with fixed backlight units there is the potential for backlight units to be in the background of a captured image. Also, the use of multiple backlight units increases the size and cost of the photographic apparatus. The use of a single camera and backlight unit increases the flexibility of the system since the camera and backlight can be positioned at any angle relative to the turntable. This is simply not possible if fixed devices are used.

FIG. 23 shows a calibration mat 206 for use with the photographic apparatus 112 of the present invention. Calibration dots 208 are positioned on the calibration mat 206 to enable the detection of the position, orientation and focal length of the digital camera 120 with zoom lens 122 in each of its various positions of use. There are 32 calibration dots shown in the calibration mat 206, four dots being located on each of eight different radii dividing the mat 206 into eight equal angles. The calibration dots may have different sizes, as shown, and preferably each set of four dots on a radius has a different pattern of dot sizes compared with the other sets. The calibration mat 206 has the same calibration dots located in exactly the same positions on the front and rear of the mat.

A number of images of the calibration mat are taken by the digital camera 120 during a calibration process. The images are processed to detect the calibration dots 208 on the calibration mat 206 in the captured image. The detected calibration dots are analysed to determine a central position of the calibration mat 206 for creating supposed three-dimensional coordinates. In accordance with the supposed three-dimensional coordinates, a position, an orientation and a focal length of the digital camera 120 can be obtained from the image of the calibration dots 208 by using perspective information. Further details of the calibration process, and how the calibration data obtained is used in the generation of three-dimensional objects of models are given below.

FIG. 24 is a block diagram of a three-dimensional modelling system incorporating the photographic apparatus 112 described above. The modelling system includes a computer system 210. The computer system 210 may be any suitable personal computer and may be a PC platform conforming to the well-known PC/AT standard.

The computer system 210 includes a central processing unit (CPU) 212 that is used to execute an application program. Normally, the application program is stored in a ROM or a hard disk within the computer system 210 as object code. That program is read from storage and written into memory within the CPU 212 at system launch for execution by the computer system 210. Detailed descriptions of data flow, control flow and memory construction are omitted from the present description since they do not relate directly to the present invention and suitable implementations are well known to persons skilled in the art.

A video monitor 214 is connected to the computer system 210. A video signal to be displayed by the video monitor 214 is output from a video board 216 to which the monitor 214 is connected. The video board 216 is driven by a video driver 218, the video driver 218 consisting of a set of software programs. A keyboard 220 and mouse 222 are provided to enable an operator of the system to manually input data. Such input data are interpreted by a keyboard and mouse interface 224 to which the keyboard 220 and mouse 222 are connected of course, other data input and output devices could be used in addition to, or instead of, the video monitor 214, keyboard 220 and mouse 222 in order to enable the operator to communicate with the computer system 210.

The digital camera 120 and zoom lens 122 are connected to the computer system 210 by a Universal Serial Bus (USB) port and HUB interface 226. A USB device manager 228 manages USB port 226 (and any other USB ports under its control). The digital camera 120 and zoom lens 122 are controlled by a USB driver 230. Control functions, including image capturing, exposure control, and zoom positioning are controlled by the computer system 210.

An interface box 232, external to the computer system 210, controls communications between STM drivers 234, 236 and 238, photodetector monitor 240, lighting control unit 242 and the computer system 210. STM driver 234 drives and controls a stepping motor 244 used to tilt the mechanical tilting stage 123a of a mirror 123. STM driver 236 drives and controls the stepping motor 190 used to drive the arm drive 180. STM driver 238 drives and controls the stepping motor 168 used to drive the drive wheel arrangement 150. STM drivers 234, 236 and 238 control steeping motors 244, 190 and 168 respectively in accordance with outputs from digital-to-analogue converters (DACs) 246, 248 and 250 respectively. DACs 246, 248 and 250 each convert digital data received from the computer system 210 into analogue signals for use by the STM drivers 234, 236 and 238 respectively.

Photodetector monitor 240 detects an output from a photodetector device 176 indicating positions of one or more marks 252 composed of evaporated aluminium thin films or thin material located on a circumference of the turntable 114. The analogue output of the photodetector monitor 240 is converted into digital data by analogue-to-digital converter (ADC) 254 for use by the computer system 210.

The lighting control unit 242 has a register that controls front light unit 124 and backlight unit 132. This register is a 2-bit register, the first bit controlling front light unit 124, the second bit controlling backlight unit 132. These control signals are created in accordance with the application program of computer system 210.

The computer system 210 and interface box 232 communicate via serial interface 256 under the control of communication serial port driver (COM port driver) 258. Digital data for use by STM drivers 234, 236 and 238 are sent from CPU 212 to those STM drivers via the serial interface 256 and the appropriate DACs 246, 248 and 250. Data from photodetector monitor 240 is passed to the CPU via ADC 254 and serial interface 256.

A hard disk unit 260 stores data 262 of texture images and silhouette images. A three-dimensional object model creating program is stored in a ROM or a hard disk within the computer system 210 as an object code and is represented in the block diagram by 3D Object Modelling Engine 264. The program is read out from storage and written into a memory within the CPU 212 when the system is launched. The code is executed from the CPU 212. The application program and the model creating program communicate through a communication (COM) interface. A program for displaying a graphical user interface (GUI) for the application is stored in the CPU 212 and is represented by the GUI block 266.

The operation of the system of FIG. 24 is described briefly below. The first step is to calibrate the system. First, the camera is calibrated using the calibration mat, such as that of FIG. 23. The appropriate mat is placed on the turntable by the user and an off-line calibration routine is activated in which images of the calibration mat are taken at different angles of the camera head (such as 80 degrees, 45 degrees, 10 degrees and −70 degrees). At each of the angles of the camera head, images are taken at a different rotational position of the glass turntable 114. Once the calibration data has been obtained, the calibration mat is removed and an object to be modelled can be placed on the turntable 114. Images of the object are taken at the same positions as images of the calibration mat were taken. Using the image data and the calibration data, a three dimensional model of the object can be generated by the 3D object modelling engine 264.

Although the use of the light unit of the present invention in a photographic apparatus for generating three-dimensional models of objects has been described, the present invention is not limited to such a use.

The light system of the present invention has been described using converging lenses. Other arrangements are possible. For example, the array of converging lenses could be replaced with an array of parabolic reflectors to generate the collimated light source.

1. An apparatus for generating a silhouette of an object for use in generating a 3-dimensional model of the said object, the apparatus comprising a light projecting device, an image capturing device and an arrangement for mounting the said object between the light projecting device and the image capturing device, wherein said light projecting device includes a two-dimensional arrangement of light projecting elements, each light projecting element having a light source associated therewith, and wherein the light projecting elements are arranged to direct light towards said image capturing device, whereby a silhouette of said object is generated at said image capturing device.

2. An apparatus as claimed in claim 1, wherein the light projecting elements are arranged to direct collimated light towards said image capturing device.

3. An apparatus as claimed in claim 1, wherein the light projecting elements are arranged to direct converging light towards said image capturing device.

4. An apparatus as claimed in claim 1, wherein each light projecting element comprises a converging lens arranged to direct light from the associated light source towards said image capturing device.

5. An apparatus as claimed in claim 4, wherein each light source is positioned at the focal point of the lens with which it is associated.

6. An apparatus as claimed in claim 4, wherein each light source is positioned relative to the lens with which it is associated such that converging light is directed towards said image capturing device.

7. An apparatus as claimed in claim 4, wherein each of said converging lenses is a fresnel lens.

8. An apparatus as claimed in claim 4, wherein said converging lenses are arranged in a honeycomb pattern.

9. An apparatus as claimed in claim 8, wherein each converging lens is hexagonal.

10. An apparatus as claimed in claim 1, wherein each of said light sources is a light emitting diode.

11. An apparatus as claimed in claim 1, wherein said light projecting device further comprises an additional converging lens positioned between said light projecting elements and said object.

12. An apparatus as claimed in claim 11, wherein said additional converging lens is a fresnel lens.

13. An apparatus as claimed in claim 1, wherein each of said light sources includes a mechanical adjustment mechanism for altering the position of that light source relative to the lens with which it is associated.

14. An apparatus as claimed in claim 13, wherein each light source is moveable along an x-axis and a y-axis in order to align the light source with the centre of the lens with which it is associated.

15. An apparatus as claimed in claim 13, wherein each light source is movable along a z-axis in order to position the light source either closer to, or further away from, the lens with which it is associated.

16. An apparatus as claimed in claim 1, wherein said image capturing device includes a taking lens.

17. An apparatus as claimed in claim 4, further comprising one or more mechanical supports arranged to provide mechanical support to one or more of said lenses.

18. An apparatus as claimed in claim 1, wherein said light projecting device is movable relative to said arrangement for mounting the said object in order to generate silhouettes of said object from different view points.

19. A light projecting device arranged, in use, to generate a silhouette of an object for use in generating a 3-dimensional model of the said object, the device including a two-dimensional arrangement of light projecting elements, each light projecting element having a light source associated therewith, wherein the light projecting elements are arranged, in use, to direct collimated or converging light towards said object.

20. A method of generating a silhouette of an object, the method comprising the steps of:
placing the said object between a light projecting device and an image capturing device;
directing light from a two-dimensional arrangement of light sources within the light projecting device towards the image capturing device; and
generating a silhouette of the object at the image capturing device.

21. A method as claimed in claim 20, further comprising the step of converting the light from the light sources into either collimated or converging beams of light.
